(19) United States
(12) Patent Application Publication
(10) Pub. No.: US 2025/0165314 A1
(43) Pub. Date: May 22, 2025

(54) System And Method For Determining Application Programming Interface (API) Version Compatibility And Related API Upgrade Process

(71) Applicant: Shopify Inc., Ottawa (CA)

(72) Inventors: Andrew HASSAN, Waterloo (CA); Jimmy BOURASSA, Montréal (CA)

(73) Assignee: Shopify Inc., Ottawa (CA)

(21) Appl. No.: 18/513,881

(22) Filed: Nov. 20, 2023

(51) Int. Cl. G06F 9/54; G06F 11/07

(52) U.S. Cl. CPC G06F 9/541; G06F 11/0793

(57) ABSTRACT

A system and method are provided for determining API version compatibility. The method includes executing a first query associated with at least one operation of a computer function that utilizes an application programming interface (API), to determine whether the first query validates to a schema for the at least one operation of the computer function, for a version of the API that is higher than a version of the API that the computer function currently calls. The method also includes, responsive to the first query validating to the schema, updating metadata for the computer function to subsequently have the computer function call the higher version of the API.

### TECHNICAL FIELD

The following relates generally to facilitating compatibility between computer programs, in particular to determining API version compatibility and, additionally, to a related API upgrade process.

### BACKGROUND

Computer programs including, for example, functions that execute operations to perform tasks (e.g., using scripts), may rely on APIs as software interfaces used to communicate with other computer programs. APIs typically have a lifecycle that may include version updates, deprecation (of a version or the API entirely), or other changes that may affect compatibility of computer programs that rely on such APIs to communicate with each other.

### BRIEF DESCRIPTION OF THE DRAWINGS

Embodiments will now be described with reference to the appended drawings wherein:

FIG. 1a is an example of a computing environment in which a first computer program communicates with a second computer program via an API call.

FIG. 1b is an example of a computing environment in which a first computer application communicates with a database via an API call.

FIG. 1c is an example of a computing environment in which a function included in a first computer application communicates with a second computer application via an API call executed by the function.

FIG. 2 is an example of a computer environment in which a development environment, an extensibility environment, and a deployment environment are provided with a software as a service platform executing backend logic for providing software services.

FIG. 3 is a flow chart illustrating example operations for configuring, deploying and using an extensibility function in an application.

FIG. 4 shows an example of an app-based discount function configuration user interface.

FIG. 5a shows an example of an app-based purchase user interface showing a checkout page.

FIG. 5b shows an example of the user interface of FIG. 5a when experiencing an error condition when executing the function configured in FIG. 4.

FIG. 6 is an example of a computing device having an application that includes a function configured to call an API.

FIG. 7 shows an example of a configuration for implementing an API version compatibility engine.

FIG. 8 illustrates an API version table for functions utilizing API calls.

FIG. 9 is a flow chart illustrating example operations for executing a query associated with at least one operation of a computer function that utilizes an API.

FIG. 10 is a flow chart illustrating example operations for initiating the operations shown in FIG. 9 in response to an event.

### DETAILED DESCRIPTION

Some existing computer systems may check the version of an API it is calling at deploy time and allow or disallow the program or function based on the version declared by the program being deployed. Other computer programs that utilize APIs may check the version of the API it is calling at runtime when the program or function is allowed or disallowed based on the version. Checks at deploy time may become outdated as APIs are updated or deprecated, for example. Checks at runtime may be time consuming, computationally expensive, and/or infeasible.

An API version compatibility and upgrade process is described herein, which includes checking the compatibility of API functionality by running a validation. The validation queries the schema of a function (or other similarly configured computer program) that utilizes one or more APIs. The query validates that the function will run with an API version that has expired or is otherwise an older version than one currently available, for example, due to deprecation of the API or a version thereof. Responsive to determining that the function will run with the older/expired API version, metadata may be used to store an indication of compatibility such that the function will run with the higher version number for the API even if programmed and deployed against a deprecated version. For example, the process may include writing data to a configuration file or adding/updating an entry in a table to capture such metadata. In this way, the API version compatibility and upgrade process may be executed periodically and/or as a batch process (e.g., once per version change) rather than validating each individual function at each runtime, with the associated performance hit.

In one aspect, there is provided a computer-implemented method, comprising executing a first query associated with at least one operation of a computer function that utilizes an API, to determine whether the first query validates to a schema for the at least one operation of the computer function, for a version of the API that is higher than a version of the API that the computer function currently calls; and responsive to the first query validating to the schema, updating metadata for the computer function to subsequently have the computer function call the higher version of the API.

In certain example embodiments, the higher version of the API may be a next version compared to the version of the API that the computer function currently calls.

In certain example embodiments, the higher version of the API is a latest version.

In certain example embodiments, the method further includes executing a second query associated with the at least one operation of the computer function that utilizes the API, to determine whether the second query validates to the schema; and responsive to the second query not validating to the schema, executing a remediation action.

In certain example embodiments, the remediation action includes providing an indication that the computer function cannot be run at runtime.

In certain example embodiments, flagging the computer function for deprecation comprises one or more of sending a notification to a developer or owner of the computer function, or disabling the computer function.

In certain example embodiments, the remediation action comprises executing the second query for a version of the API that is between the version currently called and the latest version.

In certain example embodiments, the metadata comprises a runtime table storing API versions for at least one computer function.

In certain example embodiments, the computer function operates within the same computing environment as a process executing the first query.

In certain example embodiments, the process executing the first query is triggered by an event.

In certain example embodiments, wherein the event is associated with a deprecation of the API.

In certain example embodiments, the event corresponds to a period of time following the deprecation of the API.

In certain example embodiments, the event comprises failure of one of a plurality of computer functions that utilize the API to trigger a batch execution of a process comprising the first query.

In certain example embodiments, the first query performs a static validation without running the computer function in its environment.

In certain example embodiments, the first query comprises executing a GraphQL routine.

In certain example embodiments, the first query comprises operating the computer function within a test environment.

In another aspect, there is provided a system comprising at least one processor and at least one memory. The at least one memory includes computer executable instructions that, when executed by the at least one processor, cause the system to execute a query associated with at least one operation of a computer function that utilizes an application programming interface (API), to determine whether the query validates to a schema for the at least one operation of the computer function, for a version of the API that is higher than a version of the API that the computer function currently calls; responsive to the query validating to the schema, update metadata for the computer function to subsequently have the computer function call the higher version of the API; and responsive to the query not validating to the schema, execute a remediation action.

In certain example embodiments, the remediation action includes providing an indication that the computer function cannot be run at runtime.

In certain example embodiments, the remediation action comprises executing a second query for a version of the API that is between the version currently called and the latest version.

In another aspect, there is provided a computer readable medium comprising computer executable instructions that when executed by a processor, cause the processor to execute instructions comprising: executing a query associated with at least one operation of a computer function that utilizes an application programming interface (API), to determine whether the query validates to a schema for the at least one operation of the computer function, for a version of the API that is higher than a version of the API that the computer function currently calls; responsive to the query validating to the schema, updating metadata for the computer function to subsequently have the computer function call the higher version of the API; and responsive to the query not validating to the schema, executing a remediation action.

The API version compatibility and upgrade process described herein may be particularly suited to functions that are deployed by app developers within an environment that has access to, and is able to exercise certain control, over the functions. However, it can be appreciated that the compatibility and upgrade process operations described herein may be applied to any computer program or function that includes an API call.

In an example scenario described below, an extensibility environment within a software as a service (SaaS) platform such as, for example, an e-commerce platform, may enable computer functions (e.g., plug-ins, scripts, widgets, routines, apps/applications, or other computer programs or computer program portions) to be included in application/app development and application/app deployment operations. These functions may provide, for example, relatively short scripts to run repetitive tasks in a SaaS workflow, e.g., in an e-commerce workflow. An example of such a function used in an e-commerce workflow is an automated background function that runs after a shopping cart is abandoned to compose and send an email. Other examples include a fulfillment function triggered after an item is purchased, app-based discounts, etc. Such functions (or other computer programs and applications acting as or including such functions) may call one or more APIs. However, any check or validation on the APIs used by that function at deployment time may be out-of-date as functions may remain deployed and in operation for extended periods of time (e.g., months or even years). Moreover, the APIs may be deprecated periodically or from time to time. For example, the APIs may be deprecated according to a schedule that occurs during the deployment period and without necessarily being noticed by the app/function developer or operator. A runtime check is not only computationally expensive but also may be highly disruptive as it may result in functions failing to run when they are needed. Runtime errors can be particularly irritating to both merchants and users as the function may have been running smoothly in production for a long period of time only to abruptly start to fail.

To avoid these issues, the API version compatibility and upgrade process may be run from time to time after deployment (e.g., periodically or in response to an event), without requiring runtime validations. The process may be triggered and run in response to any relevant event, timeline or other trigger. For example, if an API is scheduled to be deprecated, at that time or some other time after, a batch process may be run to validate queries made by various functions that use the API.

The process may utilize any suitable API query service so long as the API query supports a schema that one can validate against. One particularly suitable API-specific query service is GraphQL, which is a query language for APIs, and provides a server-side runtime for executing queries using a system the developer defines for their data. A GraphQL service is created by defining types and fields on those types, then providing functions for each field on each type. Other types of API queries may be executed, for example, using SQL.

While API query services like GraphQL or those that utilize SQL are particularly suited to the API version compatibility and upgrade process described here (e.g., since the queries can be run without disrupting the site using the function by sending a query to a database or other endpoint and seeing what comes back), the query could be run in a test environment by sandboxing the function. Such sandboxing may be available as an option but can be avoided if the process is capable of validating queries in the environment it is used without running the entire function, thus providing a faster and computationally cheaper validation. That is, an API query service like GraphQL may enable the process to operate statically by avoiding the need to run all features in a function. GraphQL and the like may also configure the query to inspect only the elements of the function that utilize the APIs that may have been (or are known to have been) deprecated.

An example flow for the API version compatibility and upgrade process is as follows:

1) Merchant/Partner develops a function and sets the value for the API version it is designed to run with.

2) Merchant/Partner deploys functions in their shop. At this time a check is made that the API version is valid. The check may be an actual run of the function's GraphQL API calls through a query validation for the developer's stated API version.

3) API version is scheduled for deprecation at a particular date.

4) During a grace period after the deprecation date, functions built to the now-deprecated API version are inspected by the process according to the following operations:

a) For each API call stored in the function, perform query validation (e.g., using GraphQL) on a higher API version than what was declared when the function was deployed.

b) If the query is successful, increase the API version stored with that function (i.e., update metadata such as a table).

c) If the query is unsuccessful, flag the function for deprecation (e.g., communication to merchant, disabling function, etc.)

In the above flow, the “higher” API version can be the next one or may be any version that is higher than the current/programmed version. This process of transparently upgrading the function may be repeated indefinitely until the validation fails. That is, so long as the functionality continues to be supported by a higher version, the function would not be flagged for deprecation until the expected behavior is no longer present.

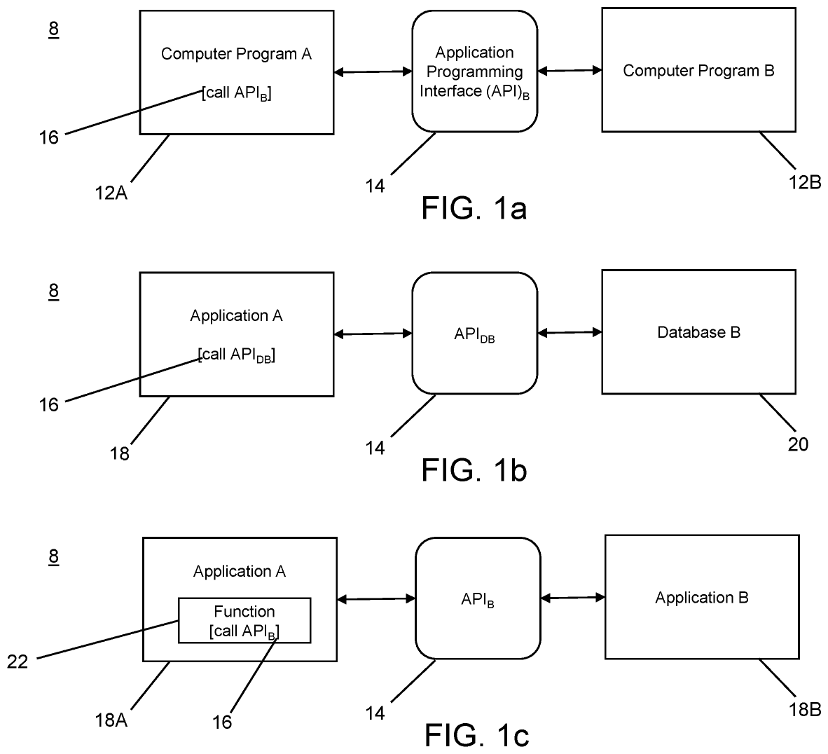

Turning now to the figures, FIG. 1a illustrates an example of a computing environment 8 in which a first computer program 12A (referred to in FIG. 1a as Computer Program A) communicates with a second computer program 12B (referred to in FIG. 1a as Computer Program B) via an API 14 to/with Computer Program B 12B, denoted API_{B}. Computer Program A 12A has been programmed or otherwise configured to include an API call 16 to API_{B}. The computer programs 12A, 12B may include any form or structure that includes a sequence or set of instructions in a programming language for a computer to execute and should not be considered limited to any of the examples provided herein.

The APIs 14 and API calls 16 illustrated herein may, additionally or alternatively, enable computer programs 12 to communicate with other computing entities. For example, FIG. 1b illustrates an example scenario in which an application 18 (referred to in FIG. 1b as Application A and providing an example of a type of computer program 12) communicates with a database 20 (referred to as Database B) via an API 14. That is, APIs 14 may be used to communicate between computer programs 12 (e.g., applications 18) and other computing entities and/or endpoints which are suitably capable of permitting access to its data and information and responding to queries or requests for such data and information. Application A 18 shown in FIG. 1b includes an API call 16 to Database B 20 via an API 14 denoted API_{DB}.

In another example scenario, shown in FIG. 1c, a first application 18A (referred to as Application A in FIG. 1c) includes a function 22. The function 22 in this example may represent an element of computer functionality such as a script, plug-in, command, module, etc. that is configured for a particular task for the application 18A. It can be appreciated that, as used herein, a function 22 may be used interchangeably or represent any computing program, code, element or module without departing from the principles discussed herein. The function 22 may therefore provide a modular element of functionality or operability for the application 18A and may include an API call 16 similar to the application itself as illustrated in FIG. 1b. That is, the function 22 may, on behalf of the application 18 in which it is embedded, communicate with another computing entity or endpoint using an API call 16 to an API 14, in this example API_{B}. Application A 18A in this example communicates with a second application 18B (referred to as Application B in FIG. 1c) via an API call 16 originating from a function 22 configured in Application A 18A.

FIGS. 1a, 1b, and 1c provide illustrative examples of computing programs 12 such as applications 18 and/or functions 22 embedded, programmed, or otherwise provided within such computing programs 12 utilizing APIs 14 to communicate with other computing entities or endpoints, such as computer programs 12, databases 20, and other applications 18 in order to perform an operation.

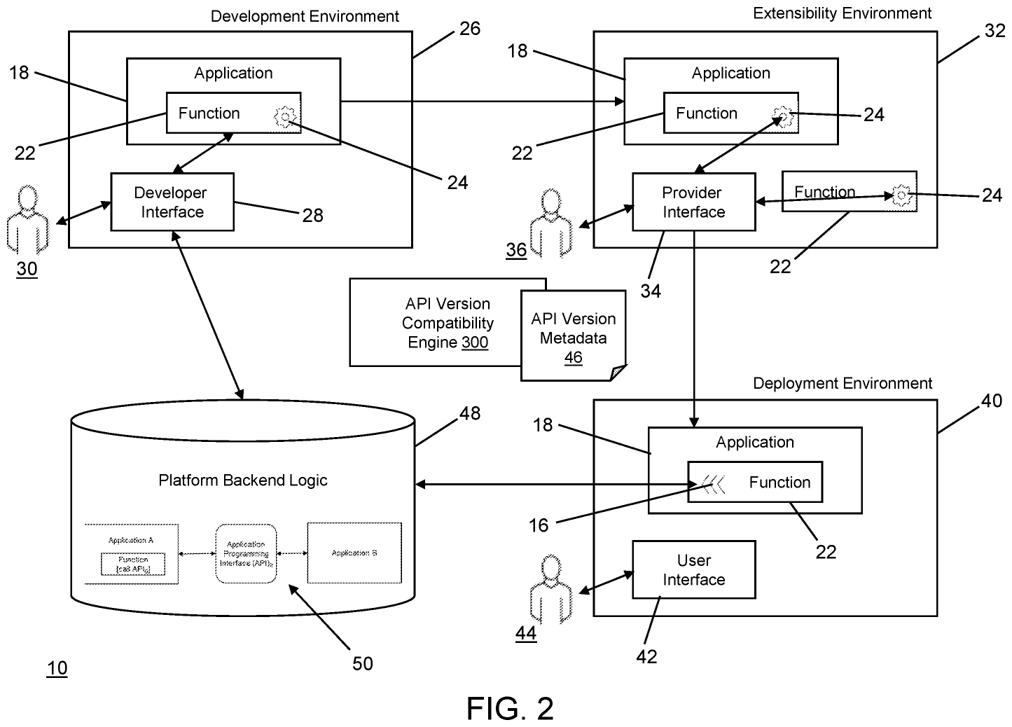

FIG. 2 illustrates an example of a computing environment 10 that may be adapted as a SaaS platform such as, for example, an e-commerce platform 100 (see, for example, FIG. 11 described later). The computing environment 10 in this example includes a development environment 26, an extensibility environment 32, a deployment environment 40, and backend logic 48 associated with the SaaS platform. It can be appreciated that the backend logic 48 shown in FIG. 2 is generally representative of various operations, functions, programs, applications, architectures, modules and other computing elements not necessarily shown in FIG. 2 for ease of illustration and thus various elements have been omitted for clarity.

The development environment 26 includes a developer interface 28 which may be utilized by a developer 30 to create an application 18. In this example, the developer 30 may include a function 22 in the application 18 being developed, which can be configured using a configuration utility 24.

The function 22 shown in FIG. 2 is one example of an extensibility option, feature, tool, plug-in or other element of program code that may be used within the computing environment 10 (e.g., by the SaaS platform) to inject code into the backend logic 48. The platform or other entity within the computing environment 10 may invoke functions 22 which have been configured for an extension target within the backend logic 48. The function's input may, for example, include a JSON object that results from a GraphQL query that is defined by the developer or implementer of the function 22. Input queries allow one to select the specific data needed for the function 22, such as product data or shipping data. The function logic may be written in any language that is able to compile functional modules which meet the function's requirements. The development environment 26 may provide function templates, client libraries and/or other utilities to enable functions 22 to be customized and configured using the configuration utility 24, e.g., to enable the function 22 to be made available to providers 36 such as merchants in the extensibility environment 32. In this example, the function output may include a JSON document that describes the operations that the developer 30 or provider 36 would like the SaaS platform to carry out in the backend logic 48. The computing environment 10 may provide GraphQL schemas that specify targets, available inputs, and expected outputs for a function API. It can be appreciated that other schemas that utilize APIs 14 may also be used.

The application 18 that is developed with a configurable function 22 may be utilized in the extensibility environment 32 to allow a provider 36 (e.g., a merchant, service provider or other entity that provides a service or product to a user 44) to incorporate or configure the function 22 to, for example, customize the application 18 for their purposes. For example, a merchant provider 36 may configure an application 18 provided by an e-commerce platform to suit their customized online shop using a provider interface 34. The provider 36 may configure the function 22 to be used in the application 18 in a way that includes an API call 16 as shown in the deployment environment 40. The deployment environment 40 in this example allows the provider 36 to create applications 18 that include functions 22, and communicate with the platform backend logic 48, to perform some customized operations for their users 44. The users 44 may interact with the application 18 within the deployment environment 40 via a user interface 42, which may include an app, web browser or other portal or access point into the provider's domain such as a storefront.

The API version compatibility and upgrade process described herein may be implemented using an API version compatibility engine 300 provided in the computing environment 10 to allow API calls 16 to be made to higher versions of an API 14 than what was originally programmed, e.g., when an API 14 is deprecated or a higher version is created that may, at some point, create an error condition due to a change in syntax, functionality, etc. The engine 300 may store and reference API version metadata 46 to permit such automatic upgrading of APIs 14.

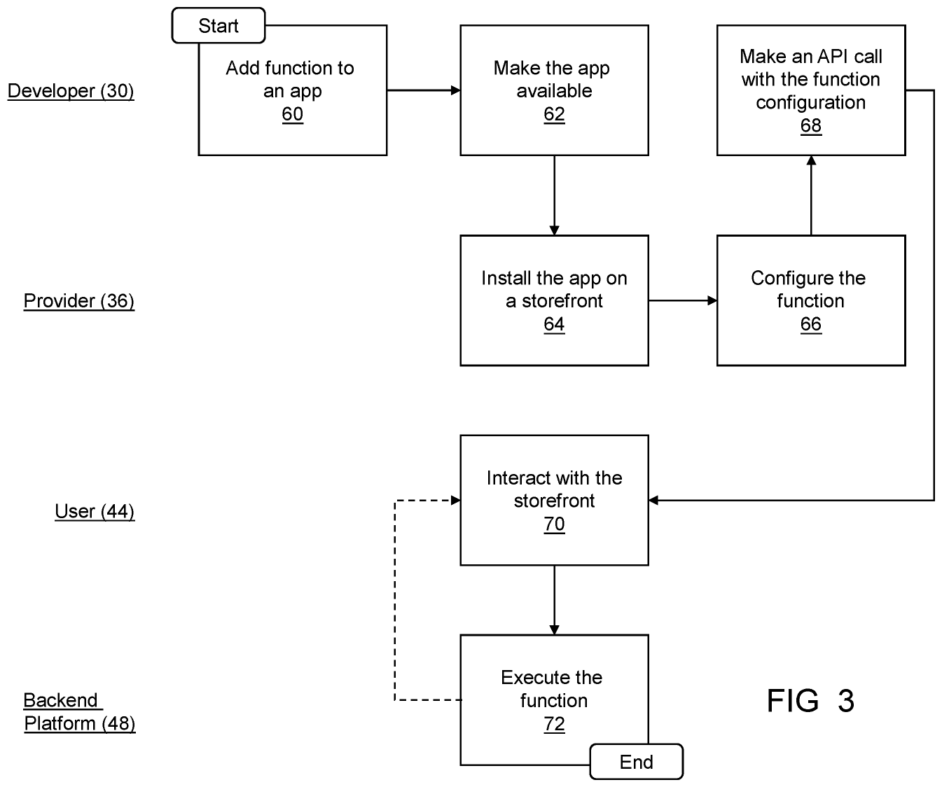

An example lifecycle for a function 22 is illustrated in FIG. 3. A developer 30 may add a function 22 to an app (e.g., application 18) at block 60 and then make the app available to providers 36 at block 62. At block 64, a provider 36 such as a merchant may install the app on a storefront and configure the function 22 at block 66. Within the development environment 26, an API call 16 may be made with the function configuration at block 68, according to the configuration at block 66. The function 22 is now operational and users 44 may interact with the storefront at block 70 in a way that triggers or otherwise utilizes the function 22. The function 22 is then executed by the platform backend logic 48 at block 72.

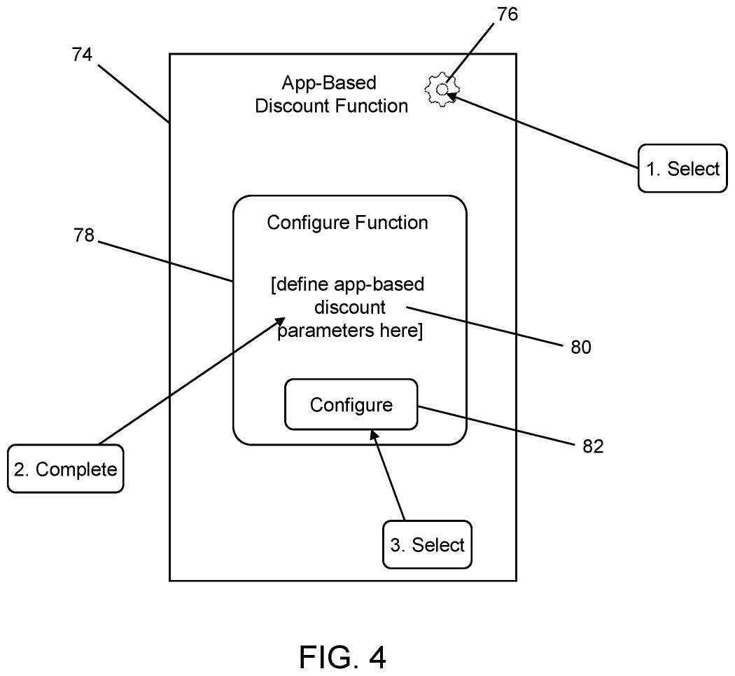

An example of a configuration UI 74 is shown in FIG. 4, for an app-based discount function 22. The UI 74 includes a configuration option 76 that may be selected to enable the provider 36 to configure the function 22. In this example, a prompt 78 is displayed which allows the provider 36 to define the app-based discount parameters 80, e.g., under what conditions the discount is provided (e.g., certain brands, certain number of items, day of week, campaign length, etc.). The provider 36 may then select a Configure option 82 to configure the app-based discount function 22 for a relevant domain such as a storefront. The app-based discount function 22 may, as described above, include at least one API call 16, which initiates a communication between computing entities as illustrated in FIG. 1.

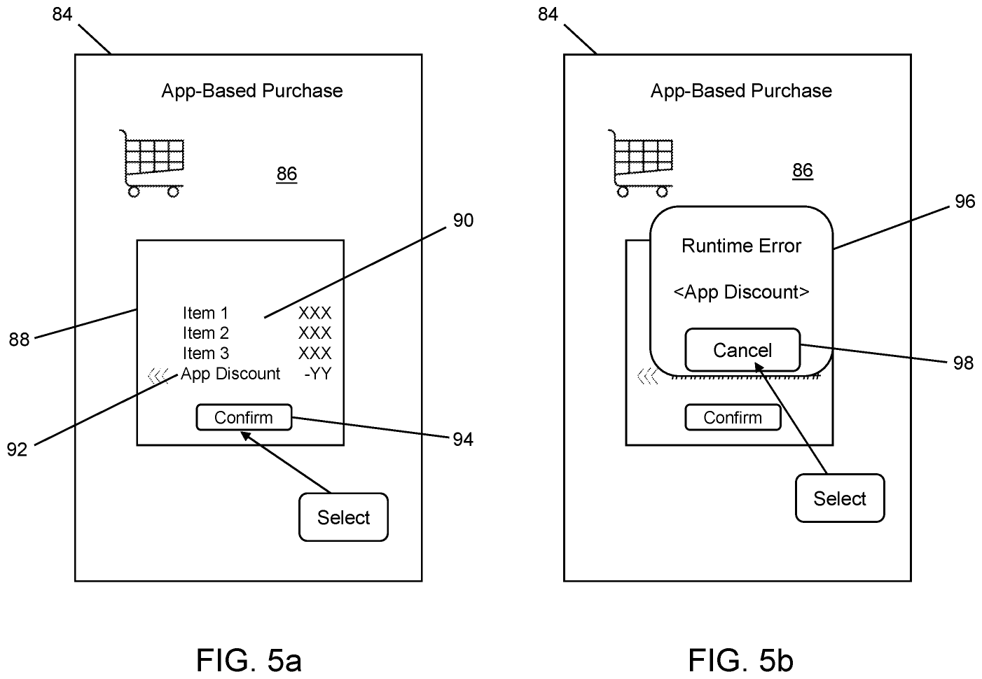

FIG. 5a illustrates an app-based purchase UI 84, for example, a shopping cart checkout page 86 in a merchant storefront. In this example, an items summary portion 88 is displayed within the checkout page 86, which lists the items 90 being purchased. Carrying on from the example in FIG. 4, an app discount 92 is also applied. As illustrated by the chevron indicia in FIG. 5a (used to denote an API call 16), the app discount 92 is associated with the configured function 22, which may include an API call 16, e.g., to determine criteria for the app discount 92, an amount to be applied, etc. A Confirm option 94 may be selected to proceed to a payment page or otherwise complete the checkout process.

Functions 22 that include API calls 16, such as the app discount 92 shown in FIG. 5a may be faced with API deprecation at some point in the function's lifecycle. For example, a function 22 may be developed for a less ephemeral functionality such as an email follow-up, cart or checkout validation, etc. Such functions 22 may be in use for several months or even years. However, when utilizing an API call 16 for an API 14 that faces deprecation, commonly known as a process of discontinuing an API 14, eventual error conditions may arise. While entire APIs 14 may be deprecated, such APIs 14 may continue to be used but under newer versions. Functions 22 that call APIs 14 of a specified version may therefore be deprecated for that version even though the API 14 continues to be made available for use within the computing environment 10.

An example of an outcome that may occur is shown in FIG. 5b, wherein a deprecated or otherwise discontinued API 14 is called that does not operate as intended or creates an error scenario. In FIG. 5b, when attempting to apply the app discount 92 after selecting the Confirm option 94, a runtime error occurs and an associated prompt 96 is displayed. The prompt 96 may include an operational button such as the Cancel option 98 shown in FIG. 5b to allow use of the function 22 (that created the error) to be canceled out. Such error conditions can be disruptive and annoying to users 44, particularly when the function 22 has been successfully operational for many months or even years, only to be non-functional upon facing a newer version of an API 14 that was called in the function 22 when originally programmed.

The API version compatibility and upgrade process described herein may be implemented to avoid or defer runtime errors or other error conditions, particularly when the functionality of an API 14, which may be facing deprecation or has otherwise been since updated to a new version, would still be operational. In the case of functions 22 used in the computing environment 10 shown in FIG. 2, API version metadata 46 may be stored and referenced to permit higher versions of an API 14 to be called than those originally written in the function's code.

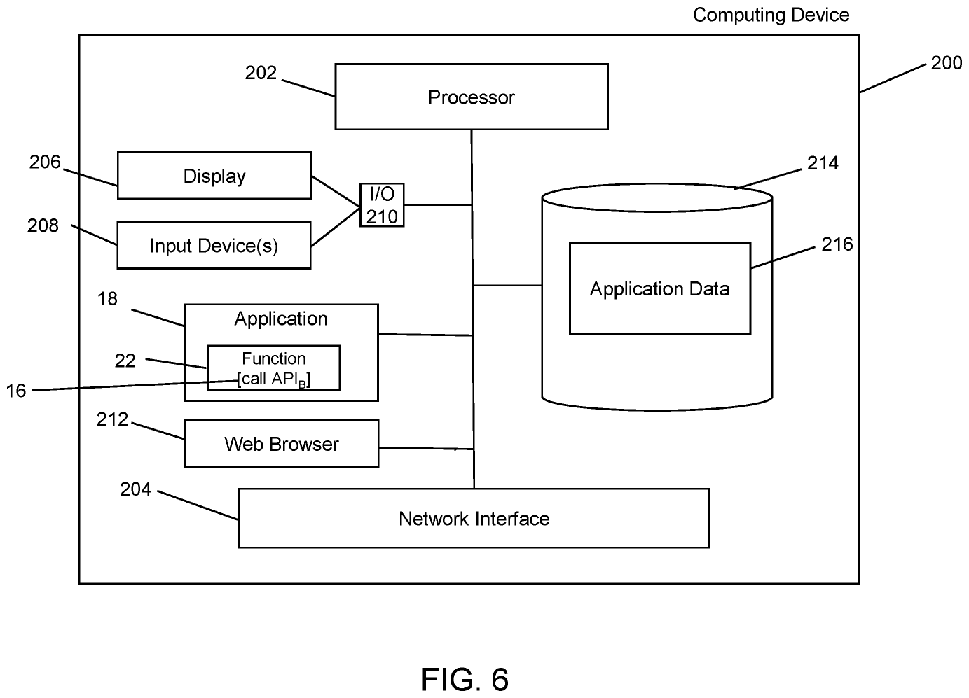

FIG. 6 shows an example of a computing device 200 implementing an example embodiment of the computing environment 10 shown in FIG. 2 and/or any computing device 200 utilized by an entity operating within the computing environment, for example, a developer 30, a provider 36, or a user 44. In this example, the computing device 200 includes one or more processors 202 (e.g., a microprocessor, microcontroller, embedded processor, digital signal processor (DSP), central processing unit (CPU), media processor, graphics processing unit (GPU) or other hardware-based processing units) and one or more network interfaces 204 (e.g., a wired or wireless transceiver device connectable to a network via a communication connection). Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc. The computing device 200 also includes a data store 214, an application 18 (which in this example includes a function 22 that utilizes at least one API call 16) and/or a web browser 212. The data store 214 may represent a database or library or other computer-readable medium configured to store data and permit retrieval of such data. The data store 214 may be read-only or may permit modifications to the data. The data store 214 may also store both read-only and write accessible data in the same memory allocation. In this example, the data store 214 stores application data 216 for the application 18.

While not delineated in FIG. 6, the computing device 200 includes at least one memory or memory device that can include a tangible and non-transitory computer-readable medium having stored therein computer programs, sets of instructions, code, or data to be executed by processor(s) 202. The processor(s) 202 and network interface(s) 204 are connected to each other via a data bus or other communication backbone to enable components of the computing device 200 to operate together as described herein. FIG. 6 illustrates examples of modules and applications stored in memory on the computing device 200 and operated by the processor(s) 202. It can be appreciated that any of the modules and applications shown in FIG. 6 may be hosted externally and be available to the computing device 200, e.g., via a network interface 204. The data store 214 in this example stores, among other things, the application data 216 that can be accessed and utilized by the application 18. The computing device 200 also includes a display 206 and one or more input device(s) 208 that may be utilized via an input/output (I/O) module 210. The web browser 212 is shown by way of example to illustrate that the application 18, or an application that is similarly configured, may be accessed by a user of the computing device 200 via a network accessible via the network interface 204. That is, an application 18 and function 22 may also be accessed and utilized by the computing device 200 from a server or other remote source and need not be a locally running application 18.

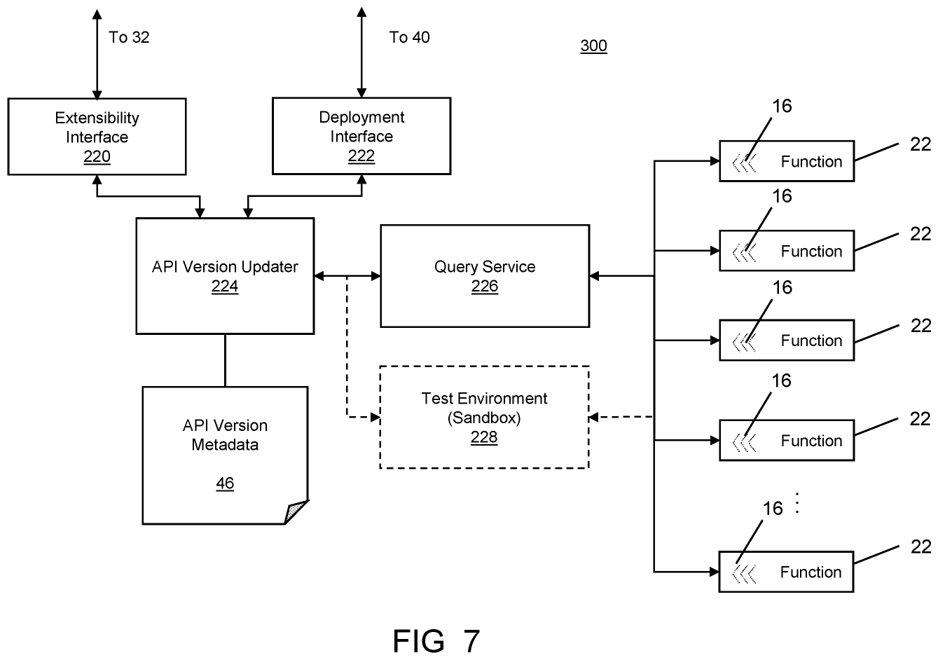

The API version compatibility and upgrade process may be implemented by, for example, the API version compatibility engine 300, which is illustrated in FIG. 7. In this example configuration, an API version updater 224 may be used to store and update the API version metadata 46. The API version updater 224 may communicate with the extensibility environment 32 via an extensibility interface 220. This allows the engine 300 to determine when a function 22 has been configured such that the API version metadata 46 may be updated to record any API calls 16, and the versions of those APIs 14 that have been called. The API version updater 224 may similarly communicate with the deployment environment 40 via a deployment interface 222. This allows the engine 300 to determine when functions 22 have been deployed and in which domains they are deployed, etc.

The API version updater 224 may utilize a query service 226, for example, GraphQL or an SQL-based query service, to query functions 22 that have been configured or have been configured and deployed, to determine if certain API versions are still compatible as used within the function 22. For example, while an API 14 may have been deprecated or have been set for deprecation, the operations performed by the function 22 may still be operational even if the API 14 has been upgraded to a newer version or replaced by another functionally similar API 14.

As illustrated in FIG. 7, the query service 226 may be utilized to query any number of functions 22 within the computing environment 10 that include API calls 16 to certain APIs 14. In this way, the API version updater 224 may execute or initiate the query service 226 in a batch process, for example, when an event is detected such as when an issue has been detected with an API 14 or the API 14 will be or has been deprecated. The query service 226 may provide a server-side runtime for executing queries statically to determine if operations associated with a function 22 validate to a schema for operation(s) of the function. Specifically, the query service 226 determines whether a version of an API 14 (called by the function 22) that is a higher version than a version of the API 14 that is currently called, remains operational. A query service 226 such as GraphQL or a similar SQL-based query, may be capable of running without disrupting the domain that utilizes the function 22 by statically sending a query to a database or other endpoint to determine what is returned and whether the data that has been returned validates to the schema. That is, when calling the API 14 for the purpose intended by the function 22 as configured, the process determines whether the function 22 continues to operate as intended. This may include determining whether the function 22 may call a higher version of the API 14 and still operate without the need to recode or reprogram the function 22 and/or application(s) 18 in which the API call 16 has been used.

It can be appreciated that, as shown in dashed lines in FIG. 7, the engine 300 may include or utilize a test environment 228 such as a sandbox to determine whether operations of a function 22 that utilize an API call 16 validate to a schema. For example, if the operations cannot be queried, or a query service 226 is unavailable, the test environment 228 may be utilized in such circumstances.

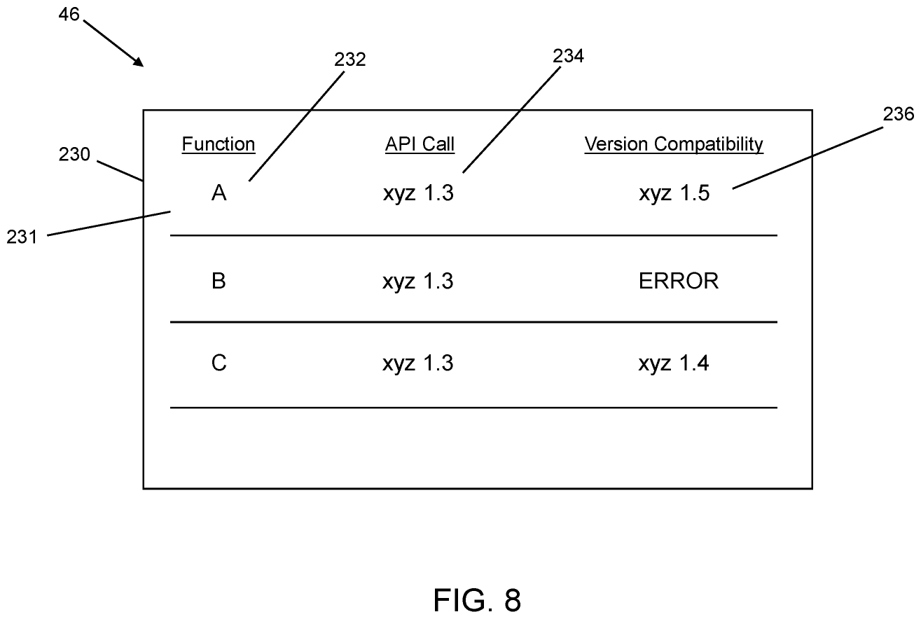

FIG. 8 illustrates an example of one type or a portion of the API version metadata 46, which may be stored and utilized by the API version updater 224. In this example the metadata 46 is structured as, or includes as a portion thereof, a table 230. The table 230 includes an entry 231 for each function 22. Each entry 231 includes a function identifier 232 such as the function name, at least one API call identifier 234, and a version compatibility identifier 236. The API call identifier 234 indicates the version of the API 14 that was originally or most recently updated to be called by the function 22. For example, when developing a function 22 in the development environment 26, the function 22 may be written to include one or more API calls 16, which each have an associated API version that would be called at that time. At the time of development, extensibility configuration, and deployment, the API calls 16 may be queried to confirm operability.

This confirmation may be performed using the query service 226 used by the engine 300 or another query service or utility used in testing or validating applications 18, functions 22, or both. In the example shown in FIG. 8, the three functions 22, namely Function A, Function B, and Function C each include the same API call 16, namely API xyz, version 1.3. For Function A, the table 230 indicates that Function A is still operable and thus compatible with version 1.5 of API xyz. However, Function B, which was programmed (or updated at some point) to call the version 1.3 of API xyz, has been found to error out due to changes made to more recent versions. This is in contrast to Function A, which will still operate even if using the later version, namely version 1.5. Function C, also listed in the table 230 indicates that this function 22 will continue to operate up to version 1.4 of API xyz. If the computing environment has deprecated version 1.3 but not yet deprecated version 1.4 (despite version 1.5 having been released since), Function C may continue to operate for at least some additional time and the table 230 indicates this accordingly. In the example shown in FIG. 8, it is assumed that API xyz may still be used for not only the latest version (e.g., version 1.5) but at least one earlier version (e.g., version 1.4). It can be appreciated that for other APIs 14 multi-version compatibility may not be permitted. On the other hand, three or more versions may be permitted in other scenarios and the API version updater 224 and API version metadata 46 may be notified and/or track this information in order to provide the most flexibility possible to prolong the lifecycle of an API 14, particular when used by up to many different functions 22.

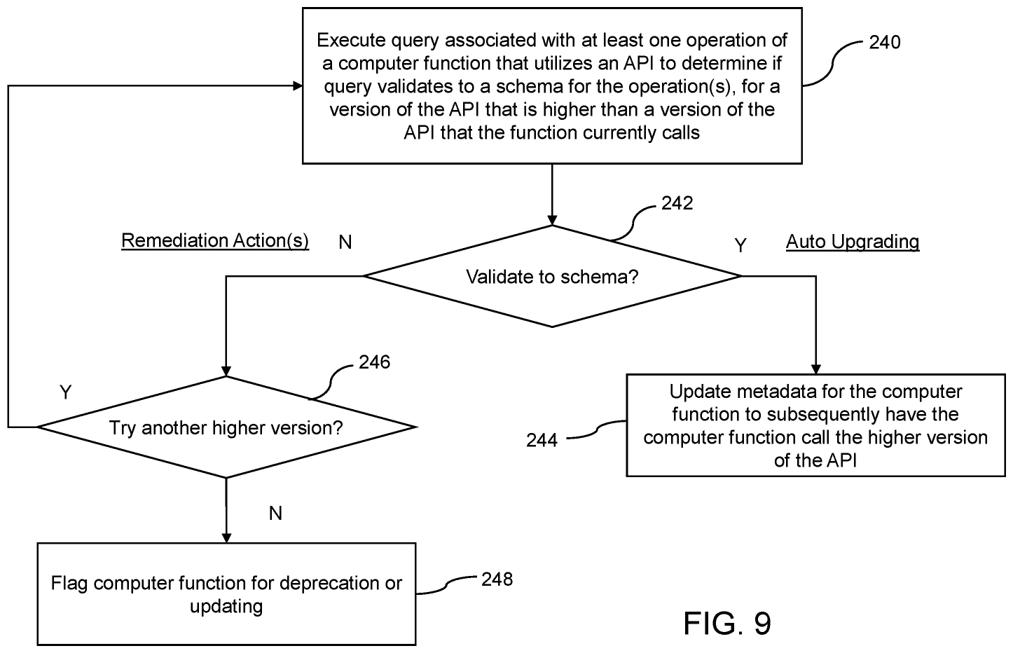

Referring now to FIG. 9, a flow chart is provided illustrating example operations for implementing the API update and compatibility process described herein.

At block 240, the API version updater 224 executes a query associated with at least one operation of a computer function 22 that utilizes an API 14 to determine if the query validates to a schema for the operation(s), for a version of the API 14 that is higher than a version of the API 14 that the function 22 currently calls. For example, the API version updater 224 may reference the table 230 to determine which version of an API 14 the function 22 was programmed to call and compare that to a most up-to-date version. If the most up-to-date version is higher, the API version updater 224 may utilize the query service 226 to determine if the function 22 will continue to operate under the higher version. It can be appreciated that the higher version may be the next highest version that is permitted to be used by the computing environment 10, the highest or latest version, or something in between.

At block 242, the API version updater 224 determines whether the query validates to the schema for the operation(s) of the function 22. Responsive to the query validating to the schema, the auto upgrading process may be implemented such that metadata 46 for the function 22 is updated such that the function 22 subsequently calls the higher version of the API 14.

Responsive to the query not validating to the schema, one or more remediation actions may be performed. For example, at block 246, the API version updater 224 may try another higher version of the API 14. In the above example, if a latest version does not validate to the schema but an intermediate version does and is still permitted within the computing environment 10, the query when repeated at block 240 would validate to the schema block 242 and the auto-upgrading would be performed at block 244.

Responsive to the repeated query not validating to the schema and/or if another higher version is unavailable or not permitted to be used within the computing environment, at block 248 the function 22 (which includes the outdated API call 16) may be flagged for deprecation (e.g., to gradually discontinue the function) or to initiate an updating process. The updating process may include a reprogramming or revision to the function's code and a redeployment or updating process pushed out to developers 30 and/or providers 36. As such, the API version updater 224 may be executed automatically as long as subsequent versions will work after which a deprecation or updating/upgrading of the function 22 itself is required. The updating/upgrading process may be initiated in various ways including over-the-air updates, communication-based notifications to the developers 30 or providers 36 or both. Redeployment may also be initiated in any suitable manner, including automated redeployment and manual processes performed by the corresponding developer 30 and/or provider 36. Redeployment may include reprogramming and/or reconfiguration of the functions 22 as needed.

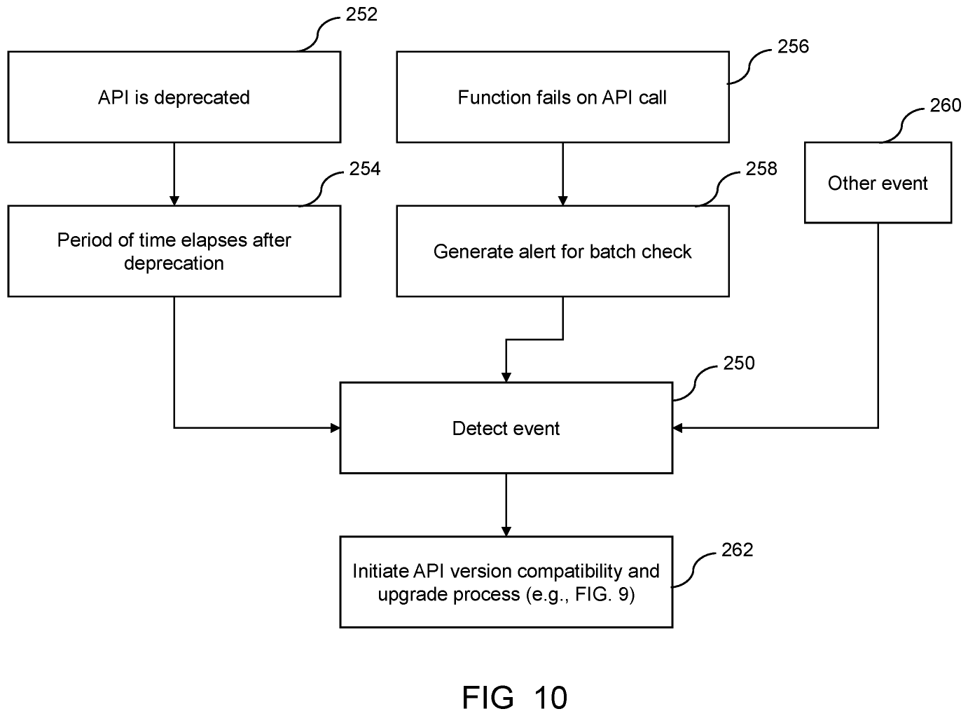

In environments such as that shown in FIG. 2, various events may be used to trigger the API version compatibility and upgrade process that is shown in FIG. 9. For example, referring now to FIG. 10, an event-based process is shown which may be used by the engine 300 (e.g., using the API version updater 224) to initiate operations shown, for example, in FIG. 9.

At block 252, one example event trigger path includes an API 14 being deprecated. For example, an API 14 may have a schedule to which it adheres for versioning or replacement or may be slated for deprecation from time to time. When the API 14 is slated for deprecation at block 252, a period of time after deprecation may be enforced at block 254 at which time an event is triggered at block 250 to initiate the process shown in FIG. 9 at block 262. The period of time after deprecation may be considered a grace period during which older versions of an API 14 are permitted to be used in parallel with newer versions before being discontinued. It can be appreciated that the period of time referred to in block 254 may vary based on the application 18 in which the function(s) 22 is/are used, the computing environment 10, the backend logic 48 and/or type of platform being used, etc.

At block 256 another example event trigger path includes the failure of a function 22 based on an API call 16. For example, when the computing environment 10 detects that a certain API call 16 caused an error in an application 18 that uses the function 22, the API version updater 224 may be initiated by communicating with the engine 300. At block 258 an alert may be generated for a batch check of all functions 22 that use that API call 16 to trigger the event detected at block 250 to initiate the process shown in FIG. 9. It can be appreciated that various other events 260 may be detected at block 250, for example, a manual input by a developer 30 or administrator, feedback received from a provider 36 or user 44, etc.

Therefore, the API version compatibility and upgrade process described herein may include checking the compatibility of API functionality by running a validation. The validation may query the schema of a function 22 (or other similarly configured computer program) that utilizes one or more APIs 14. The query validates that the function 22 will run with an API version that has expired (or may be set to expire). Responsive to determining that the function 22 runs with the expired API version, metadata 46 may be used to store an indication of compatibility such that the function will run with the higher version number for the API 14 even if programmed and deployed against a deprecated version.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, e-commerce platform 100, or engine 300, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method comprising:
executing a first query associated with at least one operation of a computer function that utilizes an application programming interface (API), to determine whether the first query validates to a schema for the at least one operation of the computer function, for a version of the API that is higher than a version of the API that the computer function currently calls; and
responsive to the first query validating to the schema, updating metadata for the computer function to subsequently have the computer function call the higher version of the API.

2. The method of claim 1, wherein the higher version of the API is a next version compared to the version of the API that the computer function currently calls.

3. The method of claim 1, wherein the higher version of the API is a latest version.

4. The method of claim 1, further comprising:
executing a second query associated with the at least one operation of the computer function that utilizes the API, to determine whether the second query validates to the schema; and
responsive to the second query not validating to the schema, executing a remediation action.

5. The method of claim 4, wherein the remediation action comprises providing an indication that the computer function cannot be run at runtime.

6. The method of claim 5, wherein flagging the computer function for deprecation comprises one or more of sending a notification to a developer or owner of the computer function, or disabling the computer function.

7. The method of claim 4, wherein the remediation action comprises executing the second query for a version of the API that is between the version currently called and the latest version.

8. The method of claim 1, wherein the metadata comprises a runtime table storing API versions for at least one computer function.

9. The method of claim 1, wherein the computer function operates within the same computing environment as a process executing the first query.

10. The method of claim 9, wherein the process executing the first query is triggered by an event.

11. The method of claim 10, wherein the event is associated with a deprecation of the API.

12. The method of claim 11, wherein the event corresponds to a period of time following the deprecation of the API.

13. The method of claim 10, wherein the event comprises failure of one of a plurality of computer functions that utilize the API to trigger a batch execution of a process comprising the first query.

14. The method of claim 1, wherein the first query performs a static validation without running the computer function in its environment.

15. The method of claim 14, wherein the first query comprises executing a GraphQL routine.

16. The method of claim 1, wherein the first query comprises operating the computer function within a test environment.

17. A system comprising:
at least one processor; and
at least one memory, the at least one memory comprising processor executable instructions that, when executed by the at least one processor, cause the system to:
execute a query associated with at least one operation of a computer function that utilizes an application programming interface (API), to determine whether the query validates to a schema for the at least one operation of the computer function, for a version of the API that is higher than a version of the API that the computer function currently calls;
responsive to the query validating to the schema, update metadata for the computer function to subsequently have the computer function call the higher version of the API; and
responsive to the query not validating to the schema, execute a remediation action.

18. The system of claim 17, wherein the remediation action comprises providing an indication that the computer function cannot be run at runtime.

19. The system of claim 17, wherein the remediation action comprises executing a second query for a version of the API that is between the version currently called and the latest version.

20. A computer-readable medium comprising processor executable instructions that, when executed by a processor of a computer system, cause the computer system to:
execute a query associated with at least one operation of a computer function that utilizes an application programming interface (API), to determine whether the query validates to a schema for the at least one operation of the computer function, for a version of the API that is higher than a version of the API that the computer function currently calls;
responsive to the query validating to the schema, update metadata for the computer function to subsequently have the computer function call the higher version of the API; and
responsive to the query not validating to the schema, execute a remediation action.
